(19) United States
(12) Patent Application Publication
(10) Pub. No.: US 2002/0067445 A1
(43) Pub. Date: Jun. 6, 2002

(54) Reflecting panel structure of reflective liquid crystal display

(76) Inventors: Yung Huang Tsai, Taichung (TW); Yi Chun Wu, Hua-Lien City (TW); Chung Yi Chen, Nan-Tou Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/729,222

(22) Filed: Dec. 5, 2000

(51) Int. Cl. G02F 1/1335

(52) U.S. Cl. 349/113

(57) ABSTRACT

A Reflecting panel structure of reflective liquid crystal display, in which the photoresistor layer laid on the substrate board is formed with multiple rough etched bottom faces and multiple protuberances. The protuberances protrude beyond the multiple etched bottom faces. The metal film disposed over the photoresistor layer is formed with multiple scattering bottom faces on the etched bottom faces thereof. The scattering bottom faces being composed of multiple irregular scattering protrusions for reflecting light beam in different directions.

### BACKGROUND OF THE INVENTION

The present invention is related to a reflecting panel structure of reflective liquid crystal display, in which the metal film disposed over the photoresistor layer is formed with multiple rough scattering bottom faces on the etched bottom faces of the photoresistor layer. The scattering bottom faces serve to scatter light beam so as to control the uniformity of the reflected light and reduce glare.

FIGS. 5, 6 and 7 show a reflecting panel of a liquid crystal display made by a conventional manufacturing method. The reflecting panel 8 of the such liquid crystal display includes a substrate board 81 which is sprayed with photoresistor 82 and preheated. Then the reflecting panel 8 is covered by a photomask 9 and exposed. Then a developer is used to develop the exposed section or not exposed section so as to form multiple protuberance 83 on the photoresistor 82. Then the semiproduct of reflecting panel 8 is placed upright and heat-treated to soften the protuberances 83 and round the surface thereof. Finally, a metal film 84 is precipitated onto the reflecting panel 8 to naturally form multiple deformed sections 841 and multiple bottom faces 842. The deformed section 841 has an asymmetrical section. Light beam is reflected by the deformed section 841 at a predetermined angle.

The photoresistor 82 of the reflecting panel 8 of the liquid crystal display is etched by an etchant. However, the etching depth is very small. Therefore, in heat-treatment, it is hardly apparent to make the protuberances 83 flow downward due to gravity and it is difficult to achieve a desired deformation amount of the deformed section 841. In FIG. 5, the substrate board 81 is tilted to help in making the asymmetrical section. However, the shape of the deformed section 841 is hard to control. Moreover, the photoresistor is thoroughly etched downward to the substrate board 81. After the metal film 84 is precipitated, the bottom faces 842 are polished faces which totally reflect the light. As a result, the reflected light is very strong and glare. A human eye can hardly stare the panel for a long time and clearly see the picture shown by the display.

### SUMMARY OF THE INVENTION

It is therefore a primary object of the present invention to provide a reflecting panel structure of reflective liquid crystal display. Multiple scattering bottom faces are formed on the photoresistor layer faces. The scattering bottom faces have multiple scattering protrusions with different inclination angles for scattering and reflecting light beam in different directions. In addition, uniform micro-mirror faces of the metal film serve to reflect the light beam in unified direction. Therefore, the screen of the liquid crystal display can be more clear and the glare is reduced so that a user can see and read for a long time.

It is a further object of the present invention to provide the above reflecting panel structure of reflective liquid crystal display, in which the photoresistor layer is formed with multiple protuberances having multiple micro-protrusions with the same inclination angle. The metal film disposed on the photoresistor layer has micro-mirror faces on the protuberances. The micro-mirror faces are composed of multiple mirror face protrusions. The mirror face protrusions and the micro-protrusions have the same inclination angle, whereby the light beam can be reflected in a predetermined direction to achieve a better brightness.

The present invention can be best understood through the following description and accompanying drawings wherein:

### BRIEF DESCRIPTION OF THE DRAWINGS

FIG. 1 is a side sectional view of a first embodiment of the present invention;

FIG. 2 is a top view of the first embodiment of the present invention;

FIG. 3A shows that the light beam is scattered by the scattering protrusions of the scattering bottom faces of the first embodiment of the present invention;

FIG. 3B shows that the light beam is reflected by the micro-mirror faces of the first embodiment of the present invention;

FIG. 4 is a side sectional view of a second embodiment of the present invention;

FIG. 5A shows a first step of manufacturing procedure of a conventional reflecting panel of reflective liquid crystal display;

FIG. 5B shows a second step of manufacturing procedure of a conventional reflecting panel of reflective liquid crystal display;

FIG. 5C shows a third step of manufacturing procedure of a conventional reflecting panel of reflective liquid crystal display;

FIG. 5D shows a fourth step of manufacturing procedure of a conventional reflecting panel of reflective liquid crystal display;

FIG. 5E shows a fifth step of manufacturing procedure of a conventional reflecting panel of reflective liquid crystal display;

FIG. 5F shows a sixth step of manufacturing procedure of a conventional reflecting panel of reflective liquid crystal display;

FIG. 6 is a side sectional view of the conventional reflecting panel of reflective liquid crystal display; and

FIG. 7 is a top view of the conventional reflecting panel of reflective liquid crystal display.

### DETAILED DESCRIPTION OF THE PREFERRED EMBODIMENTS

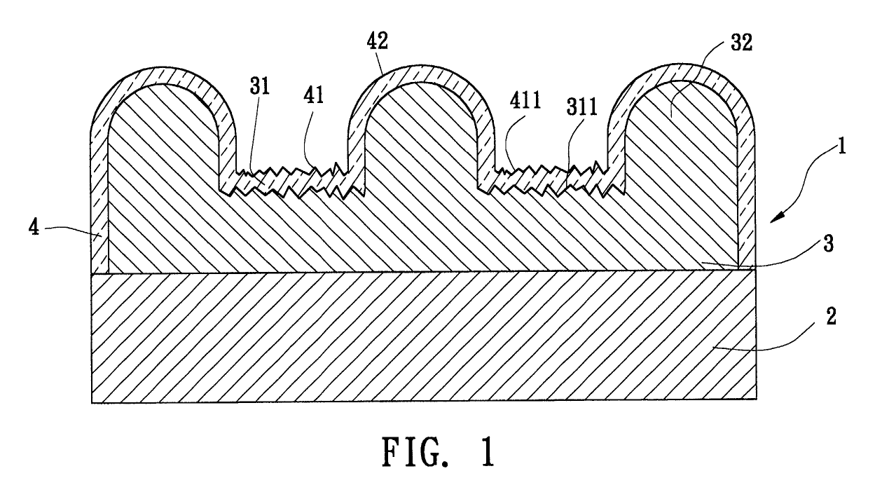

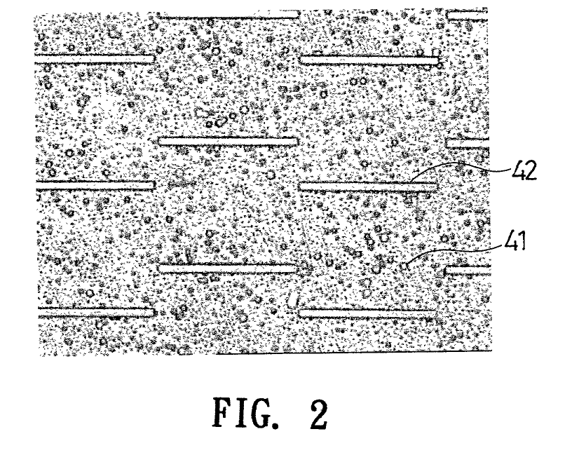

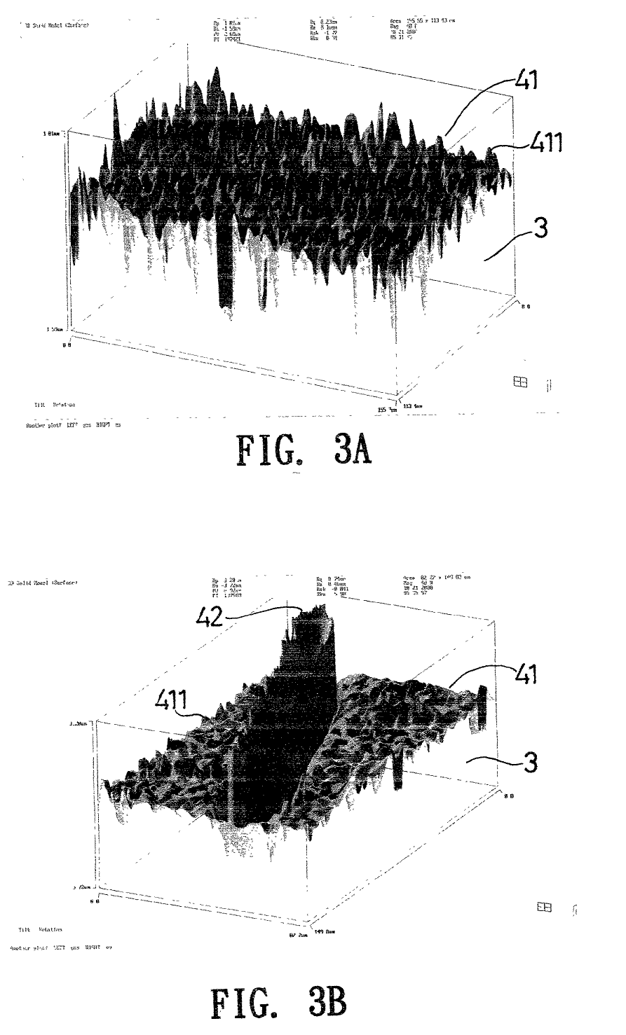

Please refer to FIGS. 1 to 3. According to a first embodiment, the reflecting panel 1 of the present invention includes:

a substrate board 2 which is a plane board made of glass and has a plane top face 21;

a photoresistor layer 3 sprayed over the top face 21 of the substrate board 1, the photoresistor layer 3 being positive or negative photoresistor, after being exposed and developed/etched, the photoresistor layer 3 being formed with multiple etched bottom faces 31 and multiple protuberances 32, the etched bottom faces 31 being formed by incompletely etching the photoresistor layer 3 in the developing/etching procedure, the photoresistor layer 3 being not so deeply etched as to touch the substrate board 2, whereby the etched bottom faces 31 are formed with rough faces composed of multiple irregular protrusions 311 having different inclination angles and heights, the protuberances 32 protruding beyond the multiple etched bottom faces 31 and having polished dome-like top sections; and

a metal film 4 disposed on the photoresistor layer 3 and isolated from the substrate board 2 by the photoresistor layer 3, the material of the metal film 4 being one of Al, Ag, Ni, Cr, etc. The metal film 4 has multiple scattering bottom faces 41 on the etched bottom faces 31 of the photoresistor layer 3 and has multiple micro-mirror faces 42 on the protuberances 32. The scattering bottom faces 41 and the etched bottom faces 31 have the same roughness. In addition, scattering protrusions 411 are laid on the protrusions 311 and have the same inclination as the protrusions 311. The multiple micro-mirror faces 42 also have dome-like top sections the same as the top sections of the protuberances 32. The micro-mirror face 42 has a cross-section which can be circular, arched, strip-shaped or polygonal or have various kinds of shapes mixedly arranged. The dimension of length, width and height of the protuberance 32 is within a range of 0.5 μm to 100 μm. The roughness of the surface of the scattering bottom face 41 is within a range of 0.1 μm to 10 μm.

The micro-mirror faces 42 of the present invention are identical to the conventional ones. By means of the metal property of the metal film 4, the light beam is reflected in a unified direction. Therefore, the liquid crystal display can achieve a better brightness of the screen. The photoresistor layer 3 is exposed in a short time or incompletely developed so that the photoresistor layer 3 is naturally formed with etched bottom faces 31. The etched bottom faces 31 have fine rough surfaces. After the metal film 4 is precipitated onto the rough surfaces, they still have the same rough surfaces to form scattering bottom faces 41. By means of the metal property of the metal film 4, the light beam is well reflected. On the other hand, the multiple scattering protrusions 411 of the scattering bottom faces 41 and the multiple protrusions 311 have different heights and angles. Therefore, the light will not be reflected by the multiple scattering protrusions 411 in the same direction and the light will be scattered. Such scattering effect serves to uniform the light reflected by the micro-mirror faces 42 so as to reduce glare and make the screen of the liquid crystal display more clear.

In conclusion, the scattering protrusions 411 of the scattering bottom faces 41 serve to scatter light beam so as to control the uniformity of the reflected light and reduce glare, whereby the screen of the liquid crystal display is more clear for a user to see and read for a long time.

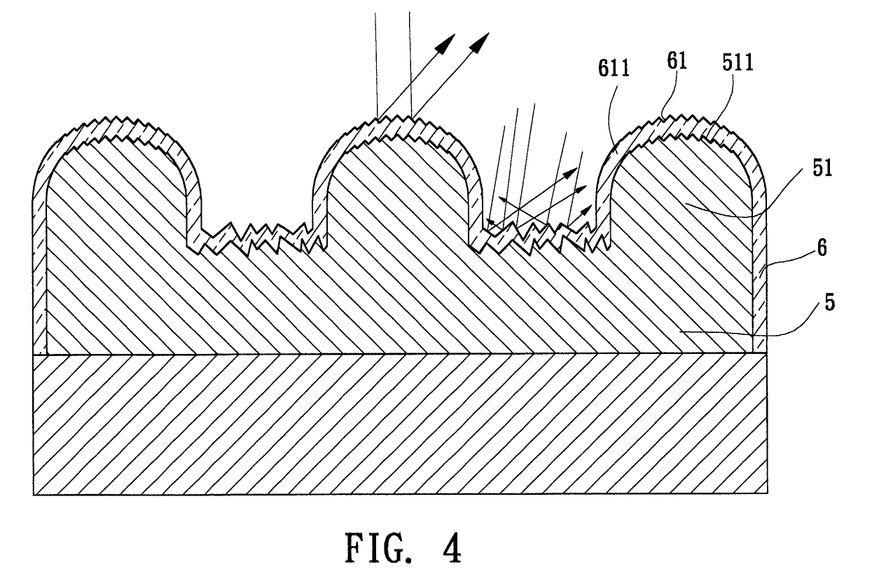

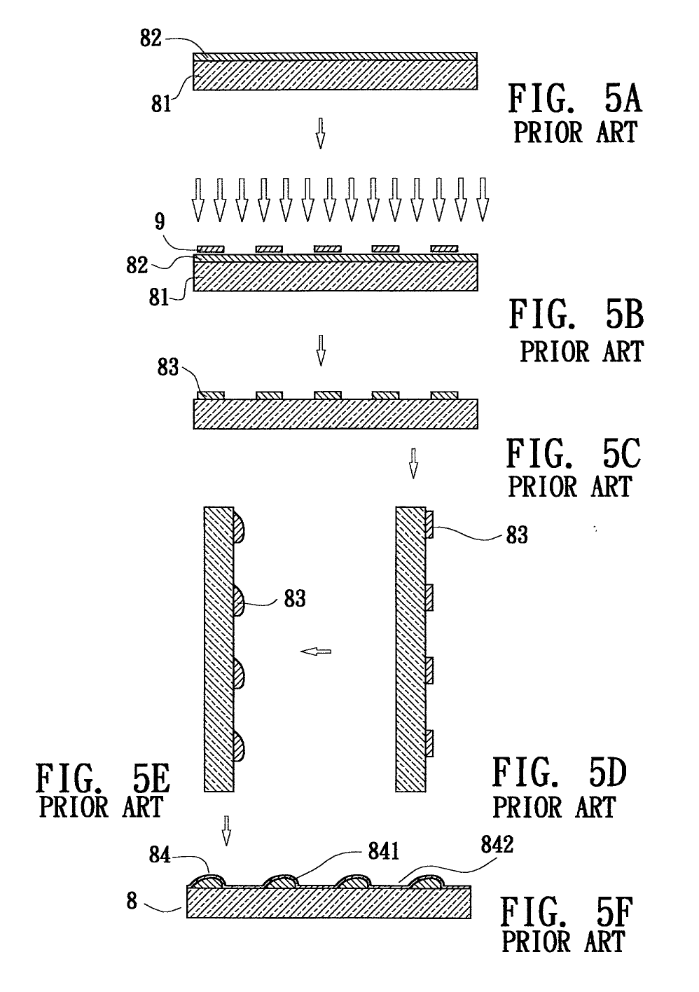

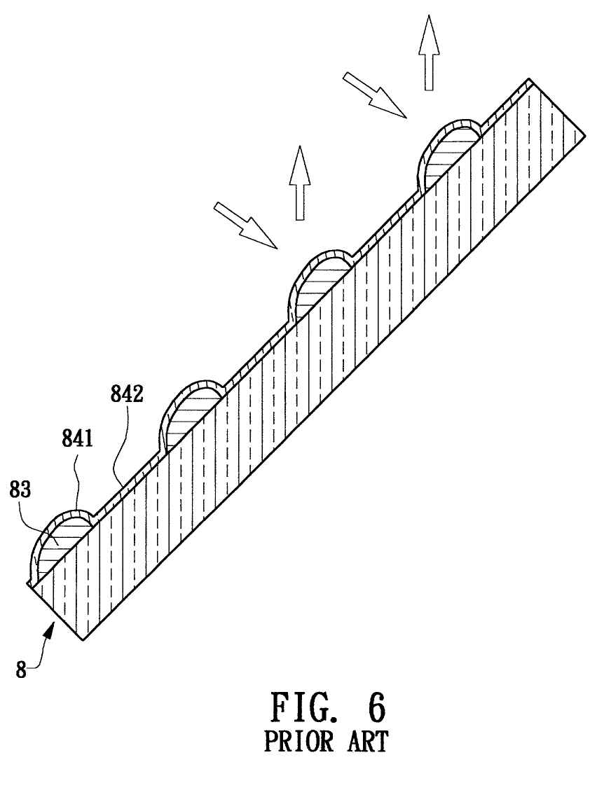

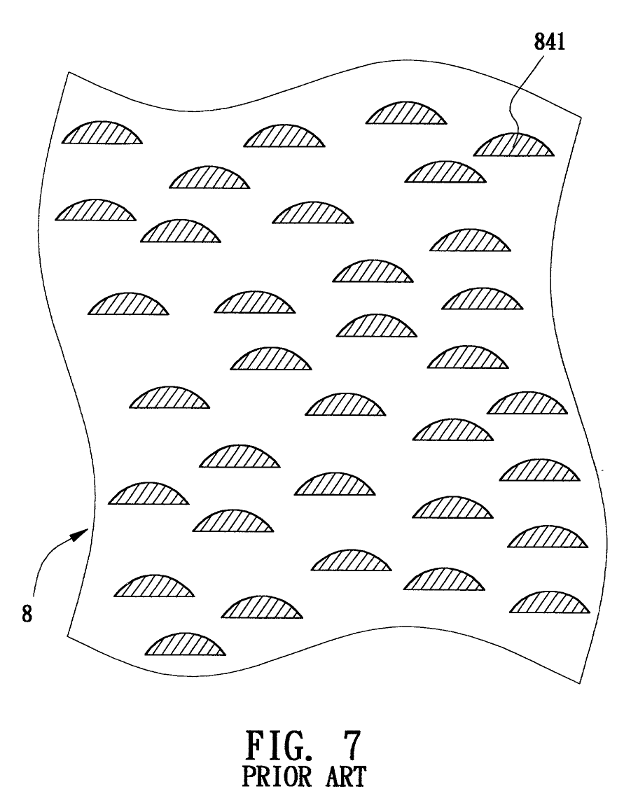

FIG. 4 shows a second embodiment of the present invention, in which the photoresistor layer 5 is formed with multiple protuberances 51 having dome-like top sections. The protuberances 51 have multiple micro-protrusions 511 with the same inclination angle. A metal film 6 is disposed on the photoresistor layer 5 and has a micro-mirror faces 61 on the protuberance 51. The micro-mirror faces 61 is composed of multiple mirror face protrusions 611. The mirror face protrusions 611 and the micro-protrusions 511 have the same inclination angle, whereby the light beam can be reflected in a predetermined direction to achieve a better brightness.

The above embodiments are only used to illustrate the present invention, not intended to limit the scope thereof. Many modifications of the above embodiments can be made without departing from the spirit of the present invention.

What is claimed is:

1. A Reflecting panel structure of reflective liquid crystal display, comprising:
a substrate board which is a plane board made of glass and has a plane top face;
a photoresistor layer sprayed over the top face of the substrate board, the photoresistor layer being formed with multiple etched bottom faces and multiple protuberances, the etched bottom faces being formed without touching the substrate board, whereby the etched bottom faces are formed with rough faces composed of multiple irregular protrusions having different inclination angles and heights, the protuberances protruding beyond the multiple etched bottom faces and having polished dome-like top sections; and
a metal film disposed on the photoresistor layer without touching the substrate board, the metal film being formed with multiple scattering bottom faces on the etched bottom faces of the photoresistor layer and has multiple micro-mirror faces on the protuberances thereof, the scattering bottom faces and the etched bottom faces having the same roughness, the scattering protrusions being laid on the protrusions and having the same inclination as the protrusions, the multiple micro-mirror faces also having dome-like top sections the same as the top sections of the protuberances.

2. A Reflecting panel structure of reflective liquid crystal display as claimed in claim 1, wherein the micro-mirror faces are circular, arched, strip-shaped or polygonal.

3. A Reflecting panel structure of reflective liquid crystal display as claimed in claim 2, wherein the micro-mirror faces have various kinds of shapes and mixedly arranged.

4. A Reflecting panel structure of reflective liquid crystal display as claimed in claim 1, wherein the roughness of the surface of the scattering bottom face is within a range of 0.1 μm to 10 μm and the dimension of length, width and height of the protuberance is within a range of 0.5 μm to 100 μm.

5. A Reflecting panel structure of reflective liquid crystal display as claimed in claim 1, wherein the protuberances of the photoresistor layer have multiple micro-protrusions with the same inclination angle, the metal film disposed on the photoresistor layer having multiple micro-mirror faces on the protuberance, the micro-mirror faces having multiple mirror face protrusions, the mirror face protrusions and the micro-protrusions have the same inclination angle.
